(19) United States
(12) Patent Application Publication
(10) Pub. No.: US 2018/0018360 A1
(43) Pub. Date: Jan. 18, 2018

(54) INFORMATION PROCESSING APPARATUS, INFORMATION PROCESSING METHOD, AND PROGRAM

(71) Applicant: NEC Personal Computers, Ltd., Tokyo (JP)

(72) Inventor: Tsuyoshi Takemoto, Tokyo (JP)

(73) Assignee: NEC Personal Computers, Ltd., Tokyo (JP)

(21) Appl. No.: 15/615,477

(22) Filed: Jun. 6, 2017

(30) Foreign Application Priority Data
Jul. 14, 2016 (JP) 2016-139751

(51) Int. Cl. G06F 17/30

(52) U.S. Cl. CPC G06F 17/30345; G06F 17/30713; G06F 17/30312; G06F 17/30705

(57) ABSTRACT

The present invention is to provide an information processing apparatus capable of updating a database without increasing the load excessively and presenting to a user, a content associated with an appropriate document. The information processing apparatus is configured to include: a document storage section that stores documents; a two-dimensional cluster generating section that generates a two-dimensional cluster in terms of documents and terms; a one-dimensional cluster generating section that generates a one-dimensional cluster in terms of the documents and the terms; a document updating section that adds and deletes documents; a two-dimensional cluster updating section which, when the documents are updated, causes the generation of the two-dimensional cluster based on the updated documents; and a one-dimensional cluster updating section that updates the one-dimensional cluster based on a delated document.

### FIELD OF THE INVENTION

The present invention relates to an information processing apparatus, an information processing method, and a program, which select a content associated with a document viewed by a user and display the content together with the document.

### BACKGROUND OF THE INVENTION

In order to add a content (such as an advertisement) to a document viewed by a user and present the content, it is important to select a content associated with a target document appropriately according to the user's taste. Patent Document 1 discloses a terminal device capable of providing an advertisement optimum for a user.

[Patent Document 1] Japanese Patent Application Publication No. 2015-22561

### SUMMARY OF THE INVENTION

Patent Document 1 discloses such a terminal device that assigns higher priority to an advertisement high in degree of user's interest corresponding to the attributes of a target document and displays the advertisement by changing the display position. Thus, the advertisement optimum for the user can be provided to the user.

It is known that accessible documents are acquired to identify the attributes of a target document based on a database in which the appearance frequencies of words included in each document are counted up. It is also known that a history of operations to each document is acquired to identify a degree of user's interest corresponding to the attributes of the document based on a database in which the appearance frequencies of words included in the document are counted up.

In a database in which the appearance frequencies of words included in documents are counted up, clustering may be performed in such a manner that words similar in appearance tendency in each document are grouped and documents similar in appearance tendency of each word are grouped. Since clustering makes it possible to identify the attributes of the documents from information on a grouped cluster, there is no need to keep detailed information on each document.

The results of clustering in the database in which the appearance frequencies of words in accessible documents are counted up may be used to grasp a degree of user's interest. Specifically, a word included in a document accessed by a user is positioned in associated information (cluster) between words and documents, which is created based on accessible documents. In this case, since there is no need to create, for each user, the associated information between words and documents, the degree of user's interest can be grasped efficiently.

When target documents are various documents accessible via a network such as news site articles on the Internet, documents are added from day to day. Further, the meaning of each word used in documents changes with the times. For example, if an entertainer who was a pop idol at first when he debuted becomes a movie actor, the cluster to which the name of the entertainer belongs will change from the pop idol to the movie actor.

In order to continue providing appropriate contents, there is a need to update such a database that counts up documents as the meaning of each word changes. To this end, there is a database update method in which documents generated after the creation of an old database are added to create a new database while keeping all documents used to create the old database.

According to this method, since the database is created based on documents accessible at the creation time, such a database as to reflect the meaning of each word at the creation time properly can be created. However, there are problems of putting pressure on the data storage capacity due to the need to keep ever-increasing documents, and increasing the load on the resources to create the database for enormous numbers of documents and hence requiring more time to create the database.

Another database update method can also be considered, in which documents are discarded while keeping only cluster information of the old database, and new documents are added to the cluster information. Since the cluster information can be defined by the range of each cluster (e.g., by the center coordinates and radius of the cluster), the amount of data can be made very small compared with that of the original documents.

However, this method cannot follow the changes of each word with time. In the above example, since the name of the entertainer who is now the movie actor continues to be associated with the pop idol at the time of creating the database, a content appropriate for the user cannot be presented.

Especially, when the degree of user's interest is grasped based on the associated information between words in accessible documents and the documents as mentioned above, there is a problem that the degree of user's interest cannot be grasped correctly if the database on the degree of user's interest is not updated in cooperation with updating of the associated information between words in accessible documents and the documents. For example, if only the associated information (cluster) on the accessible documents is updated, the range of the cluster when accessed documents are positioned can be updated later. If the content of the cluster is not consistent before and after the updating, information on documents accessed in the past cannot be used to identify the attributes of a currently targeted document.

The present invention has been made to solve the problems with updating of such a database, and it is an object thereof to provide an information processing apparatus capable of updating a database without increasing the load excessively and presenting, to a user, a content associated with a document appropriately.

In order to solve the above problems, the information processing apparatus according to the present invention includes:

a document storage section that stores each of documents acquired via a network in association with an acquisition time of the document;

a two-dimensional cluster generating section that generates, in terms of the documents and terms as words appearing in the documents, a two-dimensional cluster in which the documents similar in appearance tendency of the terms are grouped and the terms similar in appearance tendency in the documents are grouped;

a one-dimensional cluster generating section that generates a one-dimensional cluster in which the terms similar in appearance tendency in the documents are grouped;

a document updating section that adds, to the document storage section, a new document in terms of the acquisition time, and deletes, from the document storage section, an old document in terms of the acquisition time;

a two-dimensional cluster updating section that causes the two-dimensional cluster generating section to generate the two-dimensional cluster based on the documents stored in the updated document storage section after the document updating section adds and deletes the documents; and

a one-dimensional cluster updating section that updates the one-dimensional cluster based on the old document in terms of the acquisition time, which is deleted from the document storage section.

According to the present invention, there can be provided an information processing apparatus capable of updating a database without increasing the load excessively and presenting, to a user, a content associated with a document appropriately.

### BRIEF DESCRIPTION OF THE DRAWINGS

FIG. 1 is a schematic configuration diagram of an information processing system according to an embodiment of the present invention.

FIG. 2 is a functional block diagram of an information processing apparatus 1 according to the embodiment of the present invention.

FIG. 3 is a table illustrating an example of data stored in a document storage section 100.

FIG. 4 is a diagram illustrating an example of a procedure for generating a two-dimensional cluster.

FIG. 5 is a table illustrating an example of a two-dimensional cluster generated by a two-dimensional cluster generating section 110.

FIG. 6 is a table illustrating an example of a one-dimensional cluster generated by a one-dimensional cluster generating section 120.

FIG. 7 is a flowchart of cluster update processing in the information processing apparatus 1.

FIG. 8 is a flowchart of additional content acquisition/display processing in the information processing apparatus 1.

### DETAILED DESCRIPTION OF THE INVENTION

An embodiment of the present invention will be described in detail below.

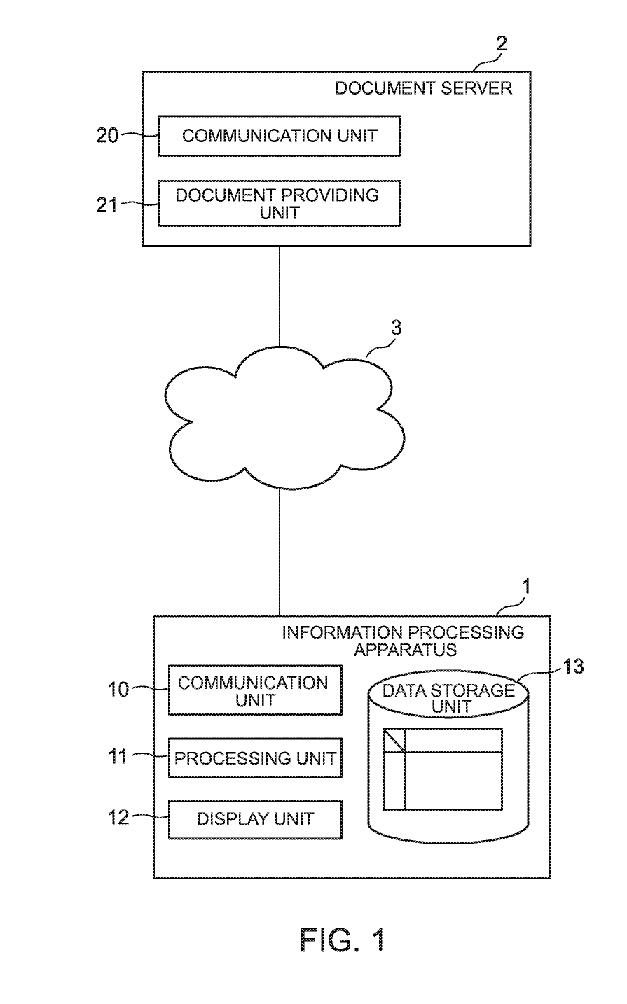

FIG. 1 is a schematic configuration diagram of an information processing system according to the embodiment of the present invention. As illustrated in FIG. 1, an information processing apparatus 1 is configured to include a communication unit 10, a processing unit 11, a display unit 12, and a data storage unit 13. A document server 2 is configured to include a communication unit 20 and a document providing unit 21. The information processing apparatus 1 and the document server 2 are connected through a network 3. The information processing apparatus 1 accesses various pieces of information accessible via the network 3, which corresponds to, but is not limited to, a personal computer or a smartphone. Further, one information processing apparatus 1 and one document server 2 are illustrated, but the information processing system is not limited to this configuration. One information processing apparatus 1 may be connected to plural document servers 2, or plural information processing apparatus 1 may be connected to one document server 2.

The communication unit 10 of the information processing apparatus 1 connects the information processing apparatus 1 to the network 3 to send and receive information. Specifically, the communication unit 10 can be configured of unillustrated wired LAN interface, wireless LAN interface, and mobile telephone communication interface, and control software or firmware therefor.

The processing unit 11 of the information processing apparatus 1 performs processing on various pieces of information. The processing for various pieces of information includes processing, which is not explicitly specified by a user, such as the control of each of units constituting the information processing apparatus 1, in addition to the execution of software specified by the user through an unillustrated input unit. The processing unit 11 can be configured of unillustrated CPU and memory.

The display unit 12 of the information processing apparatus 1 displays the information processing results by the processing unit 11 in such a manner that the user can view the results. The display unit 12 can be a display unit including a liquid crystal display panel, or a projector.

The data storage unit 13 of the information processing apparatus 1 stores various data in a nonvolatile manner. The various data may be received from the network 3 through the communication unit 10, or input through the unillustrated input unit. Further, the various data can be processing targets of the processing unit 11. The data storage unit 13 can be a nonvolatile storage device, such as a hard disk drive or an SSD (Solid State Drive).

The communication unit 20 of the document server 2 connects the document server 2 to the network 3 to send and receive information. Specifically, the communication unit 20 can be configured of unillustrated wired LAN interface, wireless LAN interface, and mobile telephone communication interface, and control software or firmware therefor.

In response to a document request accepted by the communication unit 20 via the network 3, the document providing unit 21 of the document server 2 provides a document to a requestor via the network 3. The document may be provided by transmitting a preformed and stored page, or a page dynamically generated for each request.

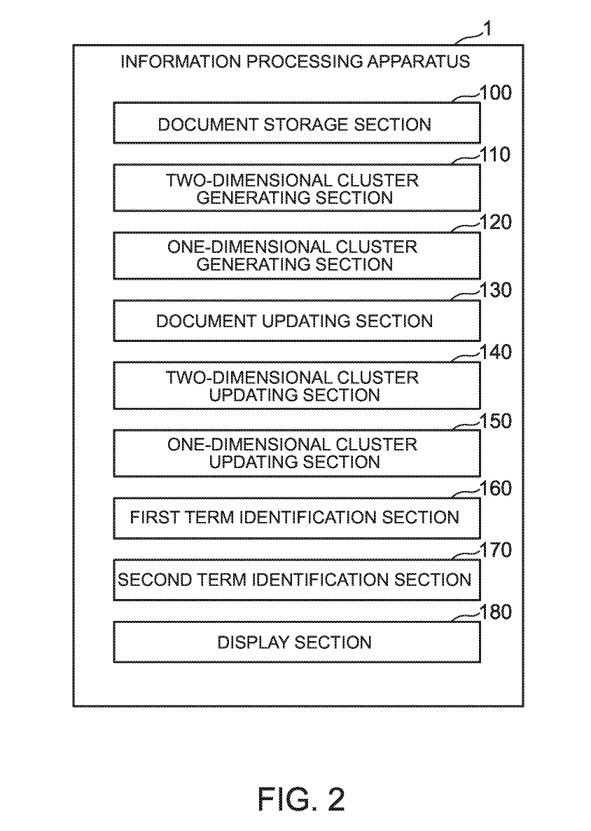

FIG. 2 is a functional block diagram of the information processing apparatus according to the embodiment of the present invention. As illustrated in FIG. 2, the information processing apparatus 1 includes a document storage section 100, a two-dimensional cluster generating section 110, a one-dimensional cluster generating section 120, a document updating section 130, a two-dimensional cluster updating section 140, a one-dimensional cluster updating section 150, a first term identification section 160, a second term identification section 170, and a display section 180.

The document storage section 100 stores each of documents acquired via a network in association with the acquisition time. The document storage section 100 may store, as targets, documents acquirable via the network regardless of the presence or absence of user accesses, or store, as targets, documents identified based on user operations on the information processing apparatus.

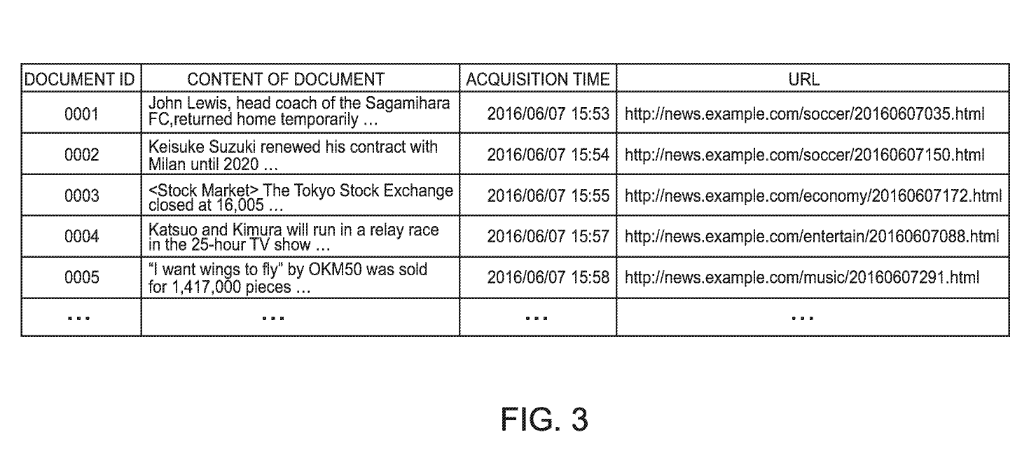

An example of data stored in the document storage section 100 is illustrated in FIG. 3. As illustrated in FIG. 3, the content of each document is stored in association with the acquisition time in the document storage section 100. Here, the document includes at least text acquired by accessing a predetermined URL (Uniform Resource Locator) via the network. As illustrated in FIG. 3, the document storage section 100 may also store a document ID uniquely identifying each document, and the URL accessed to acquire the document in association with each other in addition to the content of the document and the acquisition time.

In terms of documents and terms as words appearing in the documents, the two-dimensional cluster generating section 110 generates a two-dimensional cluster in which documents similar in appearance tendency of the terms are grouped, and terms similar in appearance tendency in the documents are grouped.

The two-dimensional cluster can be generated by grouping documents and terms based on the documents stored in the document storage section 100. Further, a two-dimensional cluster (hereinafter also referred to as UM (User Model), in which documents identified based on user operations on the information processing apparatus are targeted, can be generated by positioning, in a two-dimensional cluster (hereinafter also referred to as LM (Language Model) generated by targeting documents accessible via the network, terms appearing in the documents identified based on the user operations stored in the document storage section 100.

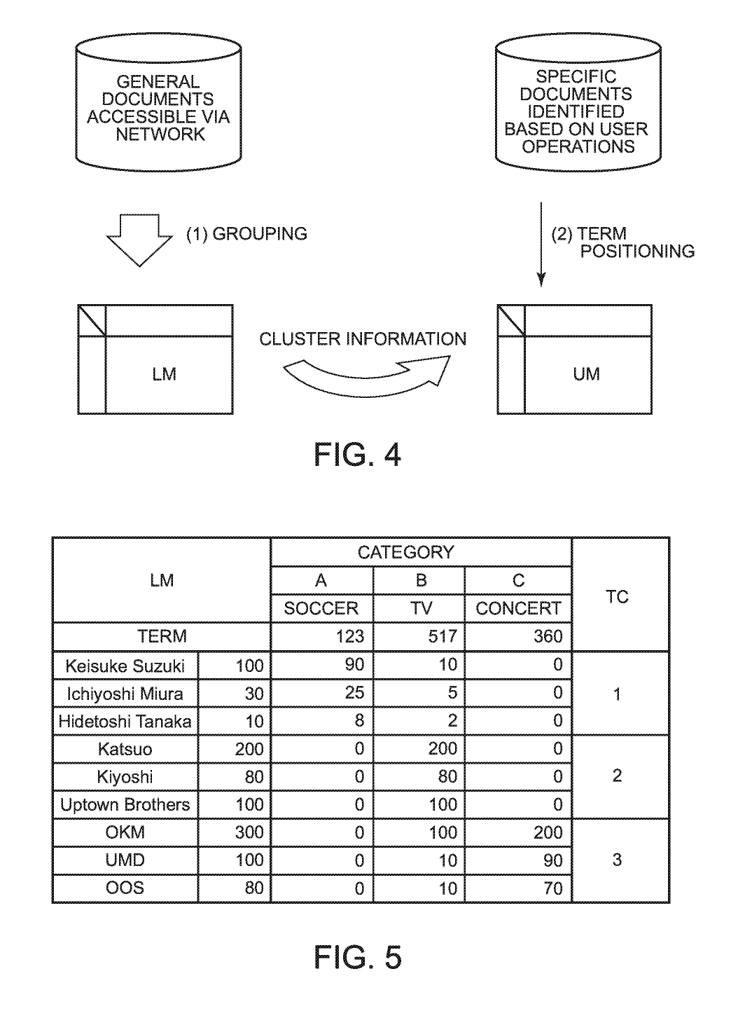

Referring to FIG. 4, an example of a procedure for generating a two-dimensional cluster as the UM will be described. As illustrated in FIG. 4, documents accessible via the network are grouped, and terms similar in appearance tendency in the documents are grouped to generate the LM. Next, the UM can be generated by positioning, in LM cluster information, the appearance frequencies of terms appearing in the documents identified based on the user operations.

Using the UM thus generated, it can be grasped which of clusters based on the appearance tendency of each word in all documents accessible via the network each user prefers. When the LM is generated on a server and the UM is generated on a user terminal, this procedure is suitable because preference information can be accumulated for each user after the LM cluster information commonly used for all users is generated collectively, but the embodiment of the present invention is not limited to this procedure.

An example of a two-dimensional cluster generated by the two-dimensional cluster generating section 110 is illustrated in FIG. 5. The generation processing for the two-dimensional cluster performed by the two-dimensional cluster generating section 110 will be described later. The two-dimensional cluster generating section 110 can be implemented by the processing unit 11 executing a predetermined program.

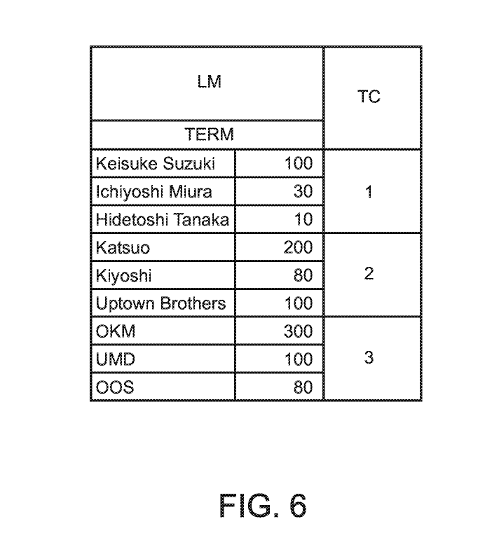

The one-dimensional cluster generating section 120 generates a one-dimensional cluster in which terms similar in appearance tendency in documents are grouped. An example of the one-dimensional cluster generated by the one-dimensional cluster generating section 120 is illustrated in FIG. 6. The generation processing for the one-dimensional cluster performed by the one-dimensional cluster generating section 120 will be described later. The one-dimensional cluster generating section 120 can be implemented by the processing unit 11 executing the predetermined program.

The document updating section 130 adds, to the document storage section 100, a new document in terms of the acquisition time, and deletes, from the document storage section 100, an old document in terms of the acquisition time. In this case, the added document and the deleted document may be controlled to make the capacities constant, controlled to make the range of acquisition times constant (e.g., one week), or controlled based on any other criterion. When the documents are controlled to make the capacities constant, the memory capacity required by the document storage section 100 can be maintained constant.

Further, the timings of addition and deletion of the documents may be simultaneous or sequential to each other. If the deletion of the document is done first, the memory capacity required by the document storage section 100 can be prevented from being increased during updating. The document updating section 130 can be implemented by the processing unit 11 executing the predetermined program.

When the document updating section 130 adds and deletes the documents, the two-dimensional cluster updating section 140 causes the two-dimensional cluster generating section 110 to generate the two-dimensional cluster based on the updated documents stored in the document storage section 100. The two-dimensional cluster updating section 140 can be implemented by the processing unit 11 executing the predetermined program.

The one-dimensional cluster updating section 150 updates the one-dimensional cluster based on the old document in terms of the acquisition time deleted from the document storage section 100. The update processing for the one-dimensional cluster performed by the one-dimensional cluster updating section 150 will be described later. The one-dimensional cluster updating section 150 can be implemented by the processing unit 11 executing the predetermined program.

Based on the two-dimensional cluster, the first term identification section 160 identifies a term associated with a content including at least a word. The term identification processing performed by the first term identification section 160 will be described later. The first term identification section 160 can be implemented by the processing unit 11 executing the predetermined program.

When no term is identified by the first term identification section 160, the second term identification section 170 identifies a term associated with the content based on the one-dimensional cluster. The term identification processing performed by the second term identification section 170 will be described later. The second term identification section 170 can be implemented by the processing unit 11 executing the predetermined program.

The display section 180 displays, together with the content, an additional content associated with the term identified by the first term identification section 160 or the second term identification section 170. The display section 180 can transmit, as a keyword, the identified term to an additional content providing server connected to the network 3 to make a request in order to acquire the additional content. The content and the additional content are displayed on the display unit 12 of the information processing apparatus 1. The display section 180 can be implemented by the processing unit 11 executing the predetermined program to control the communication unit 10 and the display unit 12.

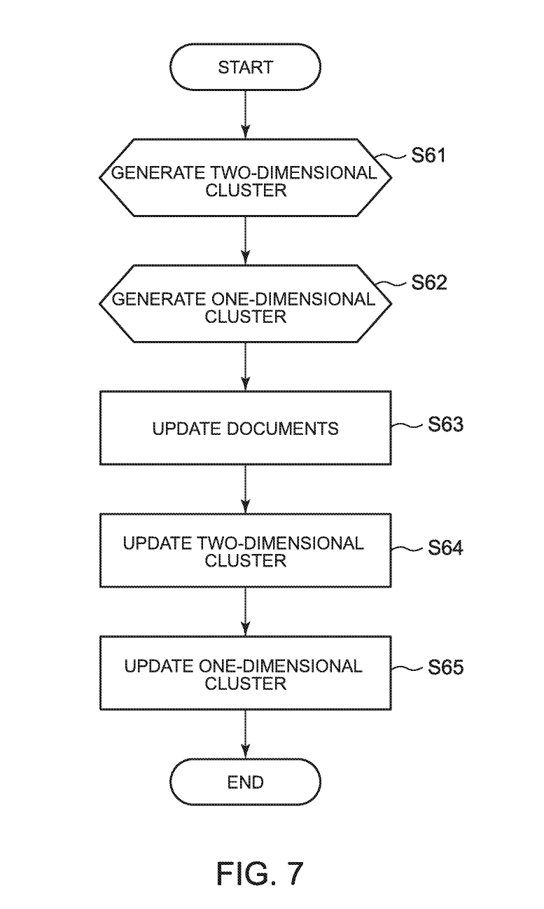

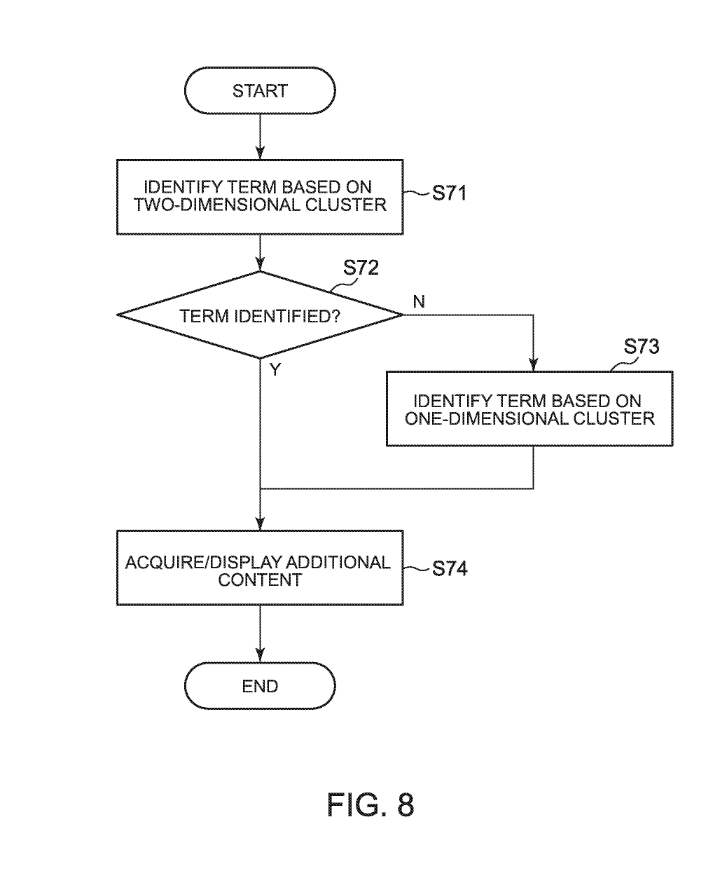

Referring next to FIG. 7 and FIG. 8, a flow of processing performed by the information processing apparatus 1 of the embodiment will be described. FIG. 7 is a flowchart of cluster update processing in the information processing apparatus 1.

Referring to FIG. 7, the information processing apparatus 1 generates a two-dimensional cluster as advance preparation (step S61). The two-dimensional cluster is generated by the two-dimensional cluster generating section 110. For example, the two-dimensional cluster can be generated in the following procedure.

First, the two-dimensional cluster generating section 110 morphologically analyzes the content of each document stored in the document storage section 100 to decompose the content of the document into words. Then, the two-dimensional cluster generating section 110 counts up the appearance frequency of each word in the document. In this case, words other than nouns, such as postpositional particles and adjectives, whose appearance tendencies do not vary from field to field to which the document is related may be excluded. Further, heavy emphasis may be placed on proper nouns, the appearance tendencies of which tend to vary pronouncedly from field to field to which the document is related.

Next, the two-dimensional cluster generating section 110 groups documents similar in appearance tendency of each word, and groups terms similar in appearance tendency in the documents. Through this grouping processing, a two-dimensional cluster in which similar documents and terms are grouped is generated. The two-dimensional cluster corresponds to a predetermined area when the documents and the terms are arranged in a two-dimensional table. When being approximated by a circle, this area can be defined by the center and radius of the circle.

In the example of FIG. 5, documents are aggregately displayed in each category to omit the listing of each individual document. Further, each figure in the table (e.g., “90” for the term “Keisuke Suzuki” in the category “Soccer”) indicates the frequency of the term appearing in documents classified in the category. The figure “123” in the category A “Soccer” indicates the sum (90+25+8+0+0+0+0+0+0) of the appearance frequencies of terms appearing in the documents grouped in the category A “Soccer”. The figure “100” for the term “UMD” indicates the sum (0+10+90) of the appearance frequencies of the term “UMD” appearing in all documents. Further, the rightmost column “TC” in the table indicates each term cluster as a group of terms similar in appearance tendency to one another in the documents. For example, “Katsuo,” “Kiyoshi,” and “Uptown Brothers” are classified in the term cluster “2.” As the appearance frequency of each term, the probability of appearance obtained by dividing the appearance frequency by the appearance frequency in all the documents, rather than the number of actual appearances.

Next, the information processing apparatus 1 generates a one-dimensional cluster as advance preparation (step S62). The one-dimensional cluster is generated by the one-dimensional cluster generating section 120. For example, the one-dimensional cluster can be generated in the following procedure.

From the two-dimensional cluster generated in step S61, the one-dimensional cluster generating section 120 extracts the terms, the appearance frequencies of the terms, and the TCs to generate the one-dimensional cluster that does not include the document category information illustrated in FIG. 5.

The processing steps S61 and S62 described above are advance preparation steps, and the execution of these processing steps is required once before a series of processes are executed. However, there is no need to execute these processes after the two-dimensional cluster and the one-dimensional cluster are generated. Note that the two-dimensional cluster and the one-dimensional cluster may as well be regenerated by using, as a trigger, a user's instruction, a lapse of a predetermined time, or the like.

Then, the information processing apparatus 1 updates the documents stored in the document storage section 100, i.e., the information processing apparatus 1 adds a new document in terms of the acquisition time to the document storage section 100, and deletes an old document in terms of the acquisition time from the document storage section 100 (step S63). The documents may be updated every predetermined period of time, updated when the capacity for documents to be updated reaches a threshold value, or updated based on any other criterion. It is also possible to update the documents based on a user operation. The documents are updated by the document updating section 130.

Next, the information processing apparatus 1 updates the two-dimensional cluster (step S64). The two-dimensional cluster is updated by the two-dimensional cluster updating section 140 in such a manner as to cause the two-dimensional cluster generating section 110 to generate a two-dimensional cluster based on the updated documents stored in the document storage section 100. The existing two-dimensional cluster is replaced by the two-dimensional cluster generated in this process.

Then, the information processing apparatus 1 updates the one-dimensional cluster (step S65). The one-dimensional cluster is updated by the one-dimensional cluster updating section 150 in the following manner: First, the content of an old document in terms of the acquisition time to be deleted from the document storage section 100 is morphologically analyzed and decomposed into words. Next, the one-dimensional cluster updating section 150 determines the frequency of appearance of each of the words decomposed from the old document in terms of the acquisition time to be deleted, and adds the determined appearance frequency to the appearance frequency of each corresponding term in the existing one-dimensional cluster. When the probability (the appearance frequency of a term/the appearance frequencies of all terms) is used as the appearance frequency, the updated probability is determined based on the figures obtained by adding the appearance frequency of the corresponding term in the existing one-dimensional cluster to both the denominator and the numerator.

Referring next to FIG. 8, processing performed by the information processing apparatus 1 to identify a term associated with a content based on the two-dimensional cluster and the one-dimensional cluster in order to acquire and display an additional content will be described. FIG. 8 is a flowchart of additional content acquisition/display processing performed by the information processing apparatus 1.

The information processing apparatus 1 first identifies a term associated with a content including at least a word based on the two-dimensional cluster (step S71). The term based on the two-dimensional cluster is identified by the first term identification section 160. Specifically, the first term identification section 160 morphologically analyzes a content to decompose the content into words. Next, the first term identification section 160 identifies a document (category) having a term appearance tendency similar to the appearance tendency of a word in this content. Then, the first term identification section 160 identifies a term high in appearance frequency in the document (category) as a term associated with the content. In this case, if the appearance tendency of the term associated with the content does not vary from document (category) to document (category), or the difference in appearance frequency between terms in the identified document (category) is not large, it will be difficult to identify a term sufficiently associated with the content. In such a case, the information processing apparatus 1 does not identify any term.

Next, the information processing apparatus 1 determines whether a term is identified in step S71 based on the two-dimensional cluster (S72). As described in step S71, no term may be identified based on the two-dimensional cluster depending on the content. The first term identification section 160 determines whether a term is identified based on the two-dimensional cluster.

When it is determined that a term is identified based on the two-dimensional cluster in step S71 (Y in step S72), the information processing apparatus 1 performs additional content acquisition processing (step S74) to be described later. On the other hand, when it is determined that no term is identified based on the two-dimensional cluster (N in step S72), the information processing apparatus 1 identifies a term associated with the content based on the one-dimensional cluster (step S73). The second term identification section 170 identifies a term based on the one-dimensional cluster.

Specifically, the second term identification section 170 acquires a word obtained by decomposing the content. Here, the second term identification section 170 may morphologically analyze the content to decompose the content, or may use the decomposing results of the first term identification section in step S71. Next, the second term identification section 170 identifies a TC in which the word included in the content appears prominently. Then, the second term identification section 170 identifies a term high in appearance frequency in the TC as a term associated with the content.

When the term is identified based on the two-dimensional cluster (Y in step S72), or when the term is identified based on the one-dimensional cluster (step S73), the information processing apparatus 1 acquires an additional content associated with the identified term, and displays the additional content together with the content (step S74). The additional content is acquired and displayed by the display section 180.

Through the processing described above, the information processing apparatus 1 can identify a term associated with a content, and acquire an additional content associated with the identified term to present, to the user, the additional content together with the content.

Since the most recent document information is reflected in the two-dimensional cluster and relatively old document information is reflected in the one-dimensional cluster, these two clusters can be used to identify an appropriate term in association with the content.

When the UM generated in a manner as illustrated in FIG. 4 is updated like in the embodiment, the latest user's taste can be grasped while keeping the user's tastes in the past. In this case, the LM is also updated like in the embodiment to update the cluster information used to generate the UM.

While the preferred embodiment of the present invention has been described in detail, the present invention is not limited to the specific embodiment, and various modifications and changes are possible within the gist of the present invention as set forth in the appended claims.

We claim:

1. An information processing apparatus comprising:
a document storage section that stores each of document acquired via a network in association with an acquisition time of each document;
a two-dimensional cluster generating section that generates, in terms of the documents and words appearing in the documents, a two-dimensional cluster in which the documents that are similar in appearance tendency of the terms are grouped and the terms that are similar in appearance tendency in the documents are grouped;
a one-dimensional cluster generating section that generates a one-dimensional cluster in which the terms that are similar in appearance tendency in the documents are grouped;
a document updating section that adds, to the document storage section, a new document in terms of its acquisition time; and deletes, from the document storage section, an old document in terms of its acquisition time;
a two-dimensional cluster updating section that causes the two-dimensional cluster generating section to generate the two-dimensional cluster based on the documents stored in the updated document storage section after the document updating section has added and/or deleted documents; and
a one-dimensional cluster updating section that updates the one-dimensional cluster based on the old document in terms of its acquisition time when it was deleted from the document storage section.

2. The information processing apparatus according to claim 1, wherein:
the one-dimensional cluster generating section groups the terms based on appearance frequencies in the documents, and
the one-dimensional cluster updating section adds the appearance frequencies of the terms in the old document in terms of acquisition times for each of the terms in the one-dimensional cluster to update the one-dimensional cluster.

3. The information processing apparatus according to claim 1, wherein the document storage section identifies, based on a user operation on the information processing apparatus, a document to be stored.

4. The information processing apparatus according to claim 1, further comprising:
a first term identification section that identifies, based on the two-dimensional cluster, a term associated with a content including at least a word;
a second term identification section which, when no term is identified by the first term identification section, identifies a term associated with the content based on the one-dimensional cluster; and
a display section that displays, together with the content, an additional content associated with the term identified by the first term identification section or the second term identification section.

5. An information processing method comprising:
a two-dimensional cluster generating step of generating, in terms of documents acquired via a network and terms as words appearing in the documents, a two-dimensional cluster in which the documents that are similar in appearance tendency of the terms are grouped and the terms that are similar in appearance tendency in the documents are grouped;
a one-dimensional cluster generating step of generating a one-dimensional cluster in which the terms that are similar in appearance tendency in the documents are grouped;
a document updating step of adding, to a document storage section that stores the documents, a new document in terms of its acquisition time; and deletes, from the document storage section, an old document in terms of its acquisition time;
a two-dimensional cluster updating step that causes the generation of the two-dimensional cluster based on the documents stored in the updated document storage section; and
a one-dimensional cluster updating step that causes updating of the one-dimensional cluster based on the old document in terms of its acquisition time when it was deleted from the document storage section.

6. A program causing a computer to execute:
a two-dimensional cluster generating step of generating, in terms of documents acquired via a network and in terms as words appearing in the documents, a two-dimensional cluster in which the documents that are similar in appearance tendency of the terms are grouped and the terms that are similar in appearance tendency in the documents are grouped;
a one-dimensional cluster generating step of generating a one-dimensional cluster in which the terms similar in appearance tendency in the documents are grouped;
a document updating step of adding, to a document storage section that stores the documents, a new document in terms of its acquisition time; and deletes, from the document storage section, an old document in terms of its acquisition time;
a two-dimensional cluster updating step of generating the two-dimensional cluster based on the documents stored in the updated document storage section; and
a one-dimensional cluster updating step of updating the one-dimensional cluster based on the old document in terms of its acquisition time when it was deleted from the document storage section.
